(19) United States
(12) Patent Application Publication
(10) Pub. No.: US 2022/0335357 A1
(43) Pub. Date: Oct. 20, 2022

(54) IDENTIFYING AN INFLUENCER COMBINATION HAVING A ROOT CAUSE TO A KEY PERFORMANCE INDICATOR CHANGE

(71) Applicant: International Business Machines Corporation, Armonk, NY (US)

(72) Inventors: Lin Luo, Carp, CA (US); Changying Sun, Ottawa, CA (US); Graham Wills, Naperville, IL (US); Damir Spisic, Chicago, IL (US)

(21) Appl. No.: 17/301,861

(22) Filed: Apr. 16, 2021

(51) Int. Cl. G06Q 10/06; G06F 16/28; G06F 16/2455

(52) U.S. Cl. CPC G06Q 10/06393; G06F 16/285; G06F 16/24553

(57) ABSTRACT

A computer-implemented method, a computer program product, and a computer system for identifying an influencer combination having a root cause to a key performance indicator change. The computer system analyzes metadata to discover semantic information for each column of data, identifies candidate factors that categorize a target performance indicators (KPI), groups the candidate factors into groups based on hierarchies which are included in the semantic information. For respective ones of the hierarchies, the computer system chooses most influential levels as influencer candidates. The computer system creates a stratified sample based on a distribution of target KPI values and evaluates an influential strength to the target KPI. The computer system identifies top influencers in the influencer candidates, based on influential strengths of respective ones of the influencer candidates.

### BACKGROUND

The present invention relates generally to data analytics, and more particularly to identifying an influencer combination having a root cause to a key performance indicator change.

In today's world, enterprises and organizations generate massive amount of data every day. To help improve business performance and drive competitive advantage, enterprises and organizations must quickly find hidden patterns and anomalies in the data, and enterprises and organizations must discover key insights to ensure better and faster decision making. There are many Key Performance Indicators (KPIs) being developed to measure business performance. A KPI value change might indicate an event has just happened or a business situation has changed. After identifying a KPI change that is worth investigating, business analysts need to perform diagnostic analytics to find a root cause of the KPI change. A crucial step of finding the root cause is to identify a set of influencers that defines a data space, which contains the root cause data points.

The state of the art for finding influencers is currently divided into two main methodologies. In the first type of methods, some applications analyze full data sets and thus have potentially high accuracy; however, the first type of methods do not scale well to large data sets and thus have limited applications to real-world data. The second type of methods use sample data to identify influencers. When sample data is used, some significant datapoints may not be included in the sample data; excluding the significant datapoints may cause an important influencer being ranked with a low score. As results of the second type of methods, the actual root cause data points may be missed out from a recommended influencer combination. Specifically, sampling data makes it very likely that outlier information will be missed.

In addition, most existing techniques use purely statistical techniques to find associations without taking into consideration of semantic relationships between the fields and target KPIs. As a result, those existing techniques have incorrectly recommended some nonsensical fields.

Business analyst rely on analytic tools to find key business insights, and furthermore to make better and faster business decision. If a user is not led to key insights correctly and quickly, the user's dissatisfaction or outright abandonment of the analytic tool may be resulted in.

### SUMMARY

In one aspect, a computer-implemented method for identifying an influencer combination having a root cause to a key performance indicator change is provided. The computer-implemented method includes analyzing metadata to discover semantic information for each column of data. The computer-implemented method further includes identifying candidate factors that categorize a target performance indicators (KPI). The computer-implemented method further includes grouping the candidate factors into groups based on hierarchies, where the hierarchies are included in the semantic information. The computer-implemented method further includes, for respective ones of the hierarchies, choosing most influential levels as influencer candidates. The computer-implemented method further includes creating a stratified sample based on a distribution of target KPI values. The computer-implemented method further includes, for each influencer candidate, evaluating an influential strength to the target KPI. The computer-implemented method further includes identifying top influencers in the influencer candidates, based on influential strengths of respective ones of the influencer candidates.

In another aspect, a computer program product for identifying an influencer combination having a root cause to a key performance indicator change is provided. The computer program product comprises a computer readable storage medium having program instructions embodied therewith, and the program instructions are executable by one or more processors. The program instructions are executable to: analyze metadata to discover semantic information for each column of data; identify candidate factors that categorize a target performance indicators (KPI); group the candidate factors into groups based on hierarchies, where the hierarchies are included in the semantic information; for respective ones of the hierarchies, choose most influential levels as influencer candidates; create a stratified sample based on a distribution of target KPI values; for each influencer candidate, evaluate an influential strength to the target KPI; and identify top influencers in the influencer candidates, based on influential strengths of respective ones of the influencer candidates.

In yet another aspect, a computer system for identifying an influencer combination having a root cause to a key performance indicator change is provided. The computer system comprises one or more processors, one or more computer readable tangible storage devices, and program instructions stored on at least one of the one or more computer readable tangible storage devices for execution by at least one of the one or more processors. The program instructions are executable to analyze metadata to discover semantic information for each column of data. The program instructions are further executable to identify candidate factors that categorize a target performance indicators (KPI). The program instructions are further executable to group the candidate factors into groups based on hierarchies, where the hierarchies are included in the semantic information. The program instructions are further executable to, for respective ones of the hierarchies, choose most influential levels as influencer candidates. The program instructions are further executable to create a stratified sample based on a distribution of target KPI values. The program instructions are further executable to, for each influencer candidate, evaluate an influential strength to the target KPI. The program instructions are further executable to identify top influencers in the influencer candidates, based on influential strengths of respective ones of the influencer candidates.

### BRIEF DESCRIPTION OF THE SEVERAL VIEWS OF THE DRAWINGS

FIG. 1(A) and FIG. 1(B) present a flowchart showing operational steps of identifying an influencer combination having a root cause to a key performance indicator change, in accordance with one embodiment of the present invention.

FIG. 2(A), FIG. 2(B), FIG. 2(C), and FIG. 2(D) illustrate an example of identifying an influencer combination having a root cause to a key performance indicator change, in accordance with one embodiment of the present invention.

FIG. 3 is a diagram illustrating components of a computing device or server, in accordance with one embodiment of the present invention.

FIG. 4 depicts a cloud computing environment, in accordance with one embodiment of the present invention.

FIG. 5 depicts abstraction model layers in a cloud computing environment, in accordance with one embodiment of the present invention.

### DETAILED DESCRIPTION

Embodiments of the present invention disclose a method for automatically identifying an influencer combination that has root cause to a KPI change. The disclosed method in the present invention accelerates user's data analytics journey by quickly bring user's focus to the right segments of data and therefore help user discover key insights faster.

The disclosed method in the present invention takes advantages of semantic information discovered from metadata to avoid nonsensical recommendations. The semantic information also helps to reduce analysis scope and allow recommendations to be created in interactive speed. The disclosed method in the present invention handles hierarchies. Only one level from a hierarchy needs to be included in a recommendation in order to avoid duplicate information. The disclosed method in the present invention uses sample data combined with outliers to make sure the strength of an influencer is not underestimated; this approach balances both performance and accuracy. The disclosed method in the present invention can generate accurate and explainable recommendations with high performance that interactive business analytics system's demand.

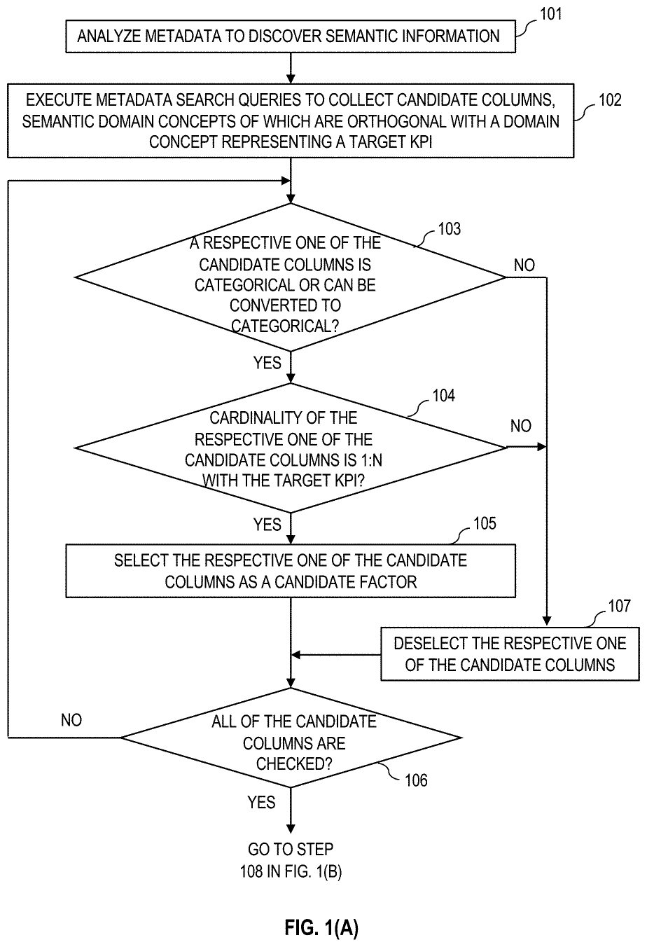

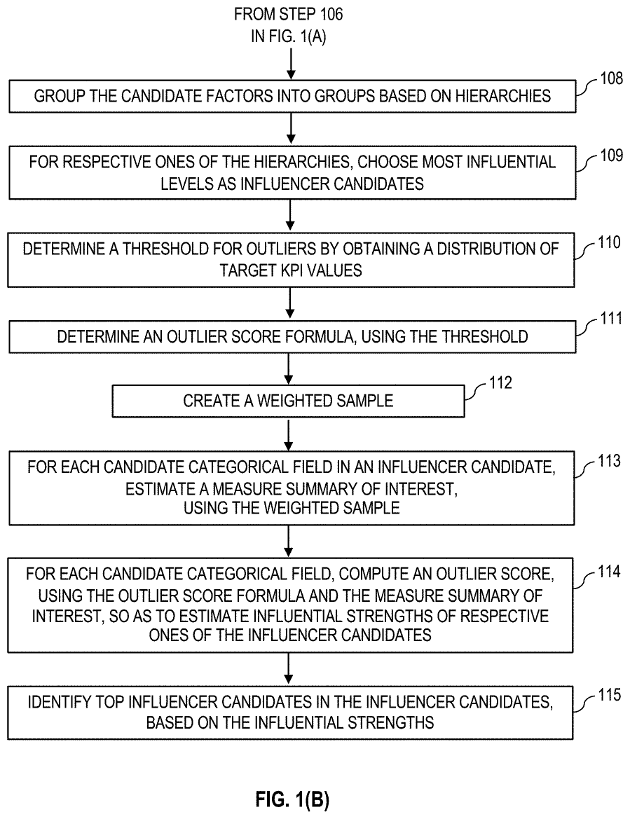

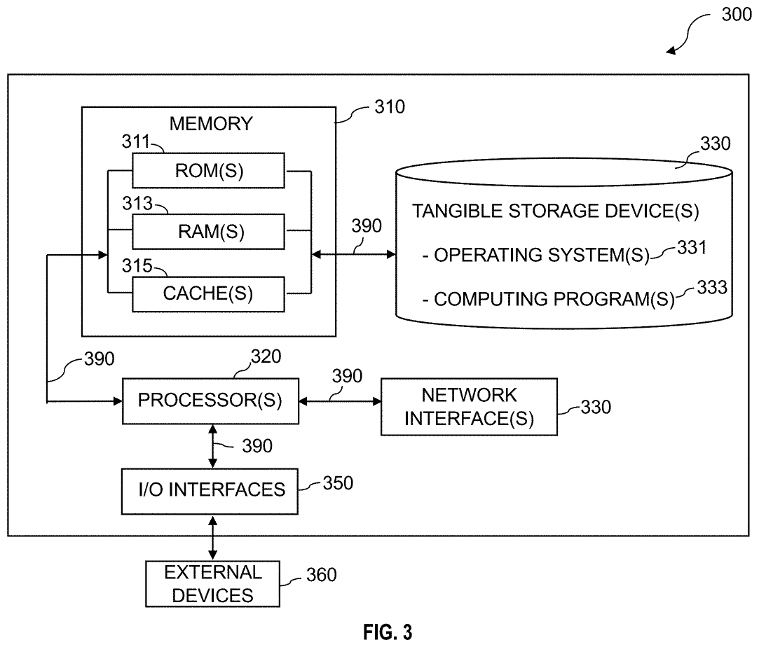

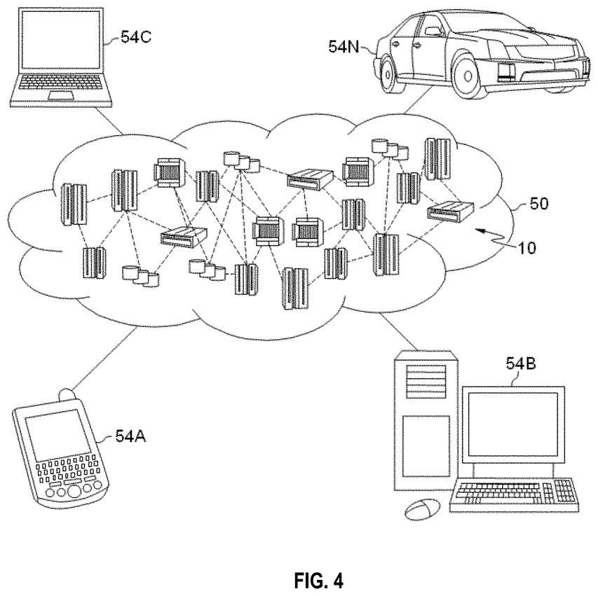

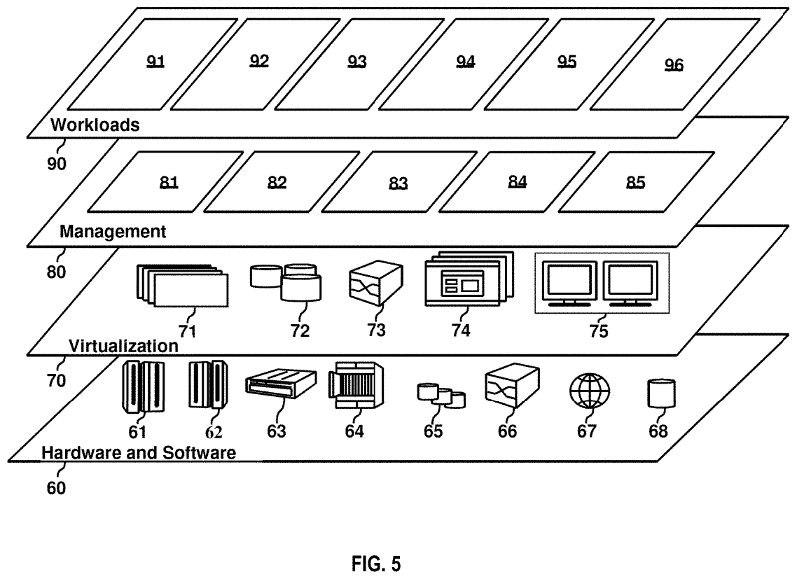

FIG. 1(A) and FIG. 1(B) present a flowchart showing operational steps of identifying an influencer combination having a root cause to a key performance indicator change, in accordance with one embodiment of the present invention. The operational steps shown in FIG. 1 are implemented by a computing device or a server. A computing device or server is described in more detail in later paragraphs with reference to FIG. 3. In some embodiments, the operational steps may be implemented in a cloud computing environment. The cloud computing environment is described in later paragraphs with reference to FIG. 4 and FIG. 5.

Referring to FIG. 1(A), at step 101, the computing device or server analyzes metadata to discover semantic information. The semantic information includes concepts and hierarchies for each column of data.

Further referring to FIG. 1(A), from step 102 to step 106, the computing device or server identifies candidate factors that categorize a key performance indicators (KPI). At step 102, the computing system or server executes metadata search queries to collect candidate columns, semantic domain concepts of which are orthogonal with a domain concept representing a target KPI.

Further referring to FIG. 1(A), at step 103 (or decision block 103), the computing device or server determines whether a respective one of the candidate columns is categorical or can be converted to categorical. In response to determining that the respective one of the candidate columns is not categorical or cannot be converted to categorical (NO branch of decision block 103), at step 107, the computing device or server deselects the respective one of the candidate columns. After deselecting the respective one of the candidate columns, the computing device or server will execute step 106.

Further referring to FIG. 1(A), in response to determining that the respective one of the candidate columns is categorical or can be converted to categorical (YES branch of decision block 103), at step 104 (or decision block 104), the computing device or server determines whether cardinality of the respective one of the candidate columns is 1:n with the target KPI. In response to determining that the cardinality of the respective one of the candidate columns is not 1:n with the target KPI (NO branch of decision block 104), at step 107, the computing device or server deselects the respective one of the candidate columns. After deselecting the respective one of the candidate columns, the computing device or server will execute step 106.

Further referring to FIG. 1(A), in response to determining that the cardinality of the respective one of the candidate columns is 1:n with the target KPI (YES branch of decision block 104), at step 105, the computing device or server selects the respective one of the candidate columns as a candidate factor. Then, the computing device or server will execute step 106.

Further referring to FIG. 1(A), at step 106 (or decision block 106), the computing device or server determines whether all of the candidate columns are checked. In response to determining that not all of the candidate columns are checked (NO branch of decision block 106), the computing device or server reiterates steps 103-106 to check a next unchecked candidate column. In response to determining that all of the candidate columns are checked (YES branch of decision block 106), the computing device or server completes a process of identifying the candidate factors for further analysis, and the computing device or server will proceed with step 108 shown in FIG. 1(B).

Now, referring to FIG. 1(B), at step 108, the computing device or server groups the candidate factors into groups based on hierarchies. Hierarchies are part of the semantic information discovered by a metadata analysis process at step 101.

Further referring to FIG. 1(B), for respective ones of the hierarchies, at step 109, the computing device or server chooses most influential levels as influencer candidates. For each hierarchy, the computing device or server iterates all levels; for each level, the computing device or server aggregates values in a target column for each member in the level. The computing device or server measures association between the level and the aggregated target column. The computing device or server picks the level with the most influence from the hierarchy as an influencer of the group (or hierarchy). The computing device or server collects influencer candidates from all of the groups for further analysis.

Further referring to FIG. 1(B), from step 110 to step 112, the computing device or server creates a stratified sample based on a distribution of target KPI values. At step 110, the computing device or server determines a threshold for outliers by obtaining a distribution of the target KPI values. At step 111, the computing device or server determines an outlier score formula, using the threshold. In another embodiment, the computing device or server may determine an outlier score formula by another value obtained from the KPI distribution, together with a dispersion statistic. At step 112, the computing device or server creates a weighted sample. The computing device or server creates the weighted sample by filtering all target KPI values above the threshold and random sampling of target KPI values below the threshold. For a filtered high target KPI value, the weight of a weighted sample will be 1; for a randomly sampled target KPI value, the weight of a weighted sample is N/n where N is the number of target KPI values below the threshold and n is the sample size.

Further referring to FIG. 1(B), from step 113 to step 114, for each influencer candidate, the computing device or server evaluates an influential strength to the target KPI. At step 113, for each candidate categorical field in an influencer candidate, the computing device or server estimates a measure summary of interest, using the weighted sample. For example, the measure summary of interest may be a sum or an average. At step 114, for each candidate categorical field, the computing device or server computes an outlier score, using the outlier score formula (obtained at step 111) and the measure summary of interest (estimated at step 113). Thus, the computing device or server estimates the influential strengths for respective ones of the influencer candidates. In evaluating the influential strengths, each candidate categorical field can be ranked by a maximum (or similar) value of outlier scores across all category values, and top candidate fields provide top outliers across all single fields.

Further referring to FIG. 1(B), at step 115, the computing device or server, identifies top influencers in the influencer candidates, based on the influential strengths of the respective ones of the influencer candidates. The influential strengths is evaluated at step 113 and step 114. The identified top influencers have the most influential effects to the target KPI and, as a result, they are recommended as an influencer combination having a root cause to a key performance indicator change.

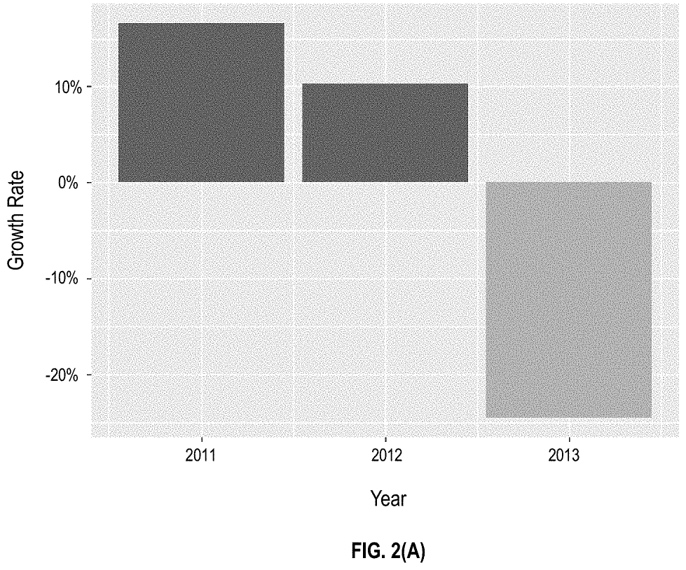

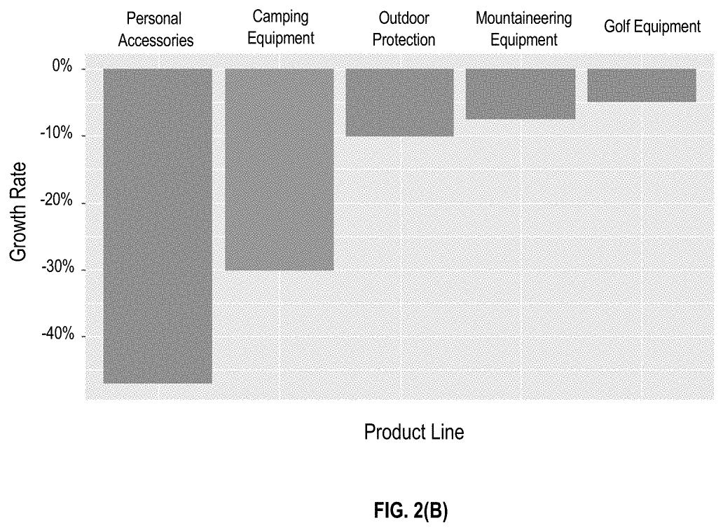

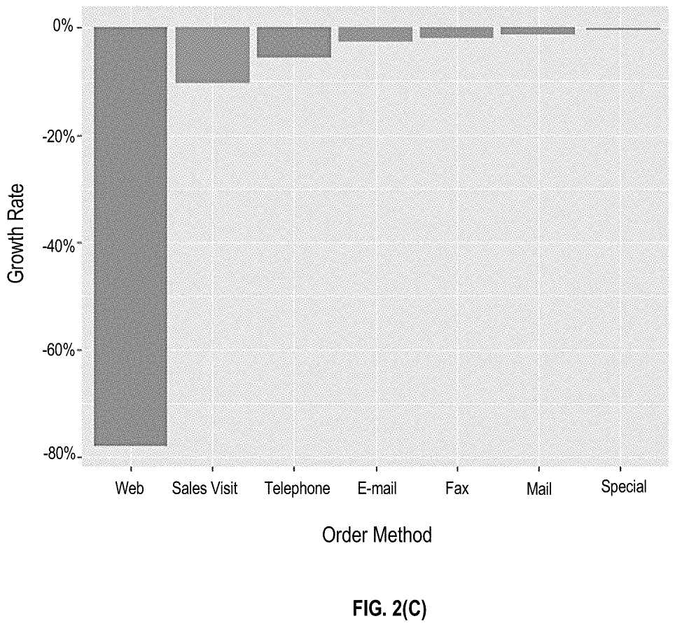

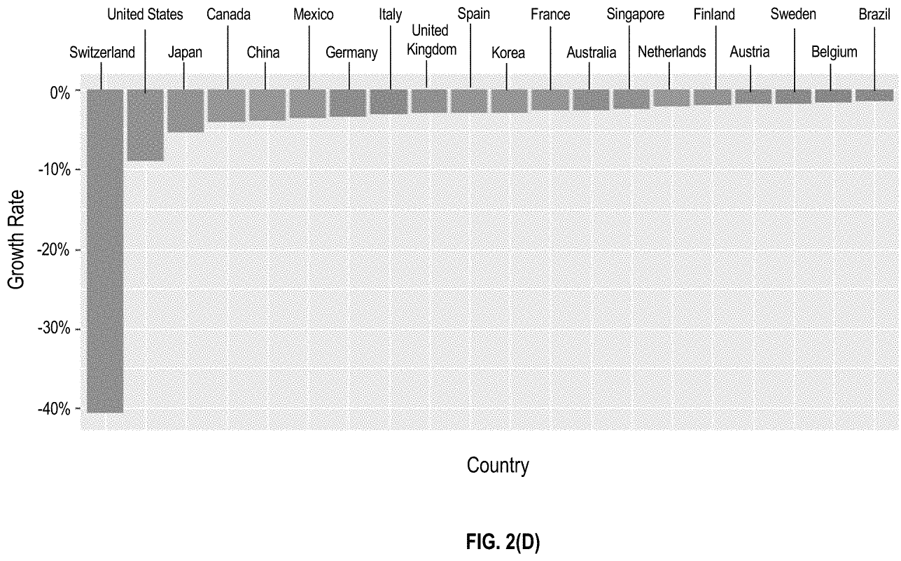

FIG. 2(A), FIG. 2(B), FIG. 2(C), and FIG. 2(D) illustrate an example of identifying an influencer combination having a root cause to a key performance indicator change, in accordance with one embodiment of the present invention. In the example, Quantity Year over Year Growth Rate is identified as a target KPI, as shown in FIG. 2(A). In FIG. 2(A), it can be noticed that the growth in 2013 is decrease.

In the example, four candidate factors categorizing the target KPI (Quantity Year over Year Growth Rate) are identified and they include Product Line, Product Type, Order Method, and Country. These four candidate factors have orthogonal domain concepts with the target KPI, categorical values, and 1 to N cardinality with the target KPI. These four candidate factors are grouped by hierarchies. Product Line and Product Type are two levels from the same hierarchy. Product Line is chosen as an influencer candidate in this hierarchy group because it has a stronger influential strength. Product Line, Order Method, and Country are chosen as influencer candidates.

In the example, a stratified sample for each influencer candidate is created based on a distribution of target KPI values. A table with KPI values is created and the threshold for outliers is determined. A query to get sample data and a outlier query to get outliers are built. In the example, the influential strength for each influencer candidate is independently evaluated. A virtual table with the target KPI for each influencer candidate is created based on the stratified sample, and the target KPI for each category is estimated. The outlier score for each category is computed.

FIG. 2(B) shows the virtual table of the target KPI for the influencer candidate Product Line. Personal Accessories and Camping Equipment are outliers from Product Line. FIG. 2(C) shows the virtual table of the target KPI for the influencer candidate Order Method. Web is an outlier from Order Method. FIG. 2(D) shows the virtual table of the target KPI for the influencer candidate Country. Switzerland and United States are outliers from Country. The results show that Product Line, Order Method, and Country are most influential to the target KPI.

FIG. 3 is a diagram illustrating components of a computing device or server, in accordance with one embodiment of the present invention. It should be appreciated that FIG. 3 provides only an illustration of one implementation and does not imply any limitations with regard to the environment in which different embodiments may be implemented.

Referring to FIG. 3, computing device or server 300 includes processor(s) 320, memory 310, and tangible storage device(s) 330. In FIG. 3, communications among the above-mentioned components of computing device or server 300 are denoted by numeral 390. Memory 310 includes ROM(s) (Read Only Memory) 311, RAM(s) (Random Access Memory) 313, and cache(s) 315. One or more operating systems 331 and one or more computer programs 333 reside on one or more computer readable tangible storage device(s) 330.

Computing device or server 300 further includes I/O interface(s) 350. I/O interface(s) 350 allows for input and output of data with external device(s) 360 that may be connected to computing device or server 300. Computing device or server 300 further includes network interface(s) 340 for communications between computing device or server 300 and a computer network.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the C programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 10 with which local computing devices are used by cloud consumers, such as mobile device 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N are intended to be illustrative only and that computing nodes 10 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and function 96. Function 96 in the present invention is the functionality of identifying an influencer combination having a root cause to a key performance indicator change.

What is claimed is:

1. A computer-implemented method for identifying an influencer combination having a root cause to a key performance indicator change, the method comprising:
analyzing metadata to discover semantic information for each column of data;
identifying candidate factors that categorize a target performance indicators (KPI);
grouping the candidate factors into groups based on hierarchies, wherein the hierarchies are included in the semantic information;
for respective ones of the hierarchies, choosing most influential levels as influencer candidates;
creating a stratified sample based on a distribution of target KPI values;
for each influencer candidate, evaluating an influential strength to the target KPI; and
identifying top influencers in the influencer candidates, based on influential strengths of respective ones of the influencer candidates.

2. The computer-implemented method of claim 1, identifying the candidate factors further comprising:
executing metadata search queries to collect candidate columns, semantic domain concepts of which are orthogonal with a domain concept representing the target KPI;
determining whether a respective one of the candidate columns is categorical or can be converted to categorical;
in response to determining that the respective one of the candidate columns is categorical or can be converted to categorical, determining whether cardinality of the respective one of the candidate columns is 1:n with the target KPI; and
in response to determining that the cardinality of the respective one of the candidate columns is 1:n with the target KPI, selecting the respective one of the candidate columns as a candidate factor.

3. The computer-implemented method of claim 2, further comprising:
in response to determining that the respective one of the candidate columns is not categorical or cannot be converted to categorical, deselecting the respective one of the candidate columns; and
in response to determining that the cardinality of the respective one of the candidate columns is not 1:n with the target KPI, deselecting the respective one of the candidate columns.

4. The computer-implemented method of claim 1, creating the stratified sample further comprising:
determining a threshold for outliers by obtaining the distribution of the target KPI values;
determining an outlier score formula, using the threshold; and
creating a weighted sample.

5. The computer-implemented method of claim 4, evaluating the influential strength further comprising:
for each candidate categorical field in an influencer candidate, estimating a measure summary of interest, using the weighted sample; and
for each candidate categorical field, computing an outlier score, using the outlier score formula and the measure summary of interest.

6. The computer-implemented method of claim 4, creating the weighted sample further comprising:
filtering all target KPI values above the threshold and randomly sampling target KPI values below the threshold;
for a filtered high target KPI value, setting a weight of the weighted sample as 1; and
for a randomly sampled target value, setting a weight of the weighted sample as N/n, where N is a number of target KPI values below the threshold and n is a sample size.

7. A computer program product for identifying an influencer combination having a root cause to a key performance indicator change, the computer program product comprising a computer readable storage medium having program instructions embodied therewith, the program instructions executable by one or more processors, the program instructions executable to:
analyze metadata to discover semantic information for each column of data;
identify candidate factors that categorize a target performance indicators (KPI);
group the candidate factors into groups based on hierarchies, wherein the hierarchies are included in the semantic information;
for respective ones of the hierarchies, choose most influential levels as influencer candidates;
create a stratified sample based on a distribution of target KPI values;
for each influencer candidate, evaluate an influential strength to the target KPI; and
identify top influencers in the influencer candidates, based on influential strengths of respective ones of the influencer candidates.

8. The computer program product of claim 7, for identifying the candidate factors, further comprising the program instructions executable to:
execute metadata search queries to collect candidate columns, semantic domain concepts of which are orthogonal with a domain concept representing the target KPI;
determine whether a respective one of the candidate columns is categorical or can be converted to categorical;
in response to determining that the respective one of the candidate columns is categorical or can be converted to categorical, determine whether cardinality of the respective one of the candidate columns is 1:n with the target KPI; and
in response to determining that the cardinality of the respective one of the candidate columns is 1:n with the target KPI, select the respective one of the candidate columns as a candidate factor.

9. The computer program product of claim 8, further comprising the program instructions executable to:
in response to determining that the respective one of the candidate columns is not categorical or cannot be converted to categorical, deselect the respective one of the candidate columns; and
in response to determining that the cardinality of the respective one of the candidate columns is not 1:n with the target KPI, deselect the respective one of the candidate columns.

10. The computer program product of claim 7, for creating the stratified sample, further comprising the program instructions executable to:
determine a threshold for outliers by obtaining the distribution of the target KPI values;
determine an outlier score formula, using the threshold; and
create a weighted sample.

11. The computer program product of claim 10, for evaluating the influential strength, further comprising the program instructions executable to:
for each candidate categorical field in an influencer candidate, estimate a measure summary of interest, using the weighted sample; and
for each candidate categorical field, compute an outlier score, using the outlier score formula and the measure summary of interest.

12. The computer program product of claim 10, for creating the weighted sample, further comprising program instructions executable to:
filter all target KPI values above the threshold and randomly sampling target KPI values below the threshold;
for a filtered high target KPI value, set a weight of the weighted sample as 1; and
for a randomly sampled target value, set a weight of the weighted sample as N/n, where N is a number of target KPI values below the threshold and n is a sample size.

13. A computer system for identifying an influencer combination having a root cause to a key performance indicator change, the computer system comprising one or more processors, one or more computer readable tangible storage devices, and program instructions stored on at least one of the one or more computer readable tangible storage devices for execution by at least one of the one or more processors, the program instructions executable to:
analyze metadata to discover semantic information for each column of data;
identify candidate factors that categorize a target performance indicators (KPI);
group the candidate factors into groups based on hierarchies, wherein the hierarchies are included in the semantic information;
for respective ones of the hierarchies, choose most influential levels as influencer candidates;
create a stratified sample based on a distribution of target KPI values;
for each influencer candidate, evaluate an influential strength to the target KPI; and
identify top influencers in the influencer candidates, based on influential strengths of respective ones of the influencer candidates.

14. The computer system of claim 13, for identifying the candidate factors, further comprising the program instructions executable to:
execute metadata search queries to collect candidate columns, semantic domain concepts of which are orthogonal with a domain concept representing the target KPI;
determine whether a respective one of the candidate columns is categorical or can be converted to categorical;
in response to determining that the respective one of the candidate columns is categorical or can be converted to categorical, determine whether cardinality of the respective one of the candidate columns is 1:n with the target KPI; and
in response to determining that the cardinality of the respective one of the candidate columns is 1:n with the target KPI, select the respective one of the candidate columns as a candidate factor.

15. The computer system of claim 14, further comprising the program instructions executable to:
in response to determining that the respective one of the candidate columns is not categorical or cannot be converted to categorical, deselect the respective one of the candidate columns; and
in response to determining that the cardinality of the respective one of the candidate columns is not 1:n with the target KPI, deselect the respective one of the candidate columns.

16. The computer system of claim 13, for creating the stratified sample, further comprising the program instructions executable to:
determine a threshold for outliers by obtaining the distribution of the target KPI values;
determine an outlier score formula, using the threshold; and
create a weighted sample.

17. The computer system of claim 16, for evaluating the influential strength, further comprising the program instructions executable to:
for each candidate categorical field in an influencer candidate, estimate a measure summary of interest, using the weighted sample; and
for each candidate categorical field, compute an outlier score, using the outlier score formula and the measure summary of interest.

18. The computer system of claim 16, for creating the weighted sample, further comprising program instructions executable to:
filter all target KPI values above the threshold and randomly sampling target KPI values below the threshold;
for a filtered high target KPI value, set a weight of the weighted sample as 1; and
for a randomly sampled target value, set a weight of the weighted sample as N/n, where N is a number of target KPI values below the threshold and n is a sample size.
